(19) United States
(12) Patent Application Publication
(10) Pub. No.: US 2002/0168173 A1
(43) Pub. Date: Nov. 14, 2002

(54) Method and apparatus for copying and processing audiovisual information

(76) Inventors: Wilhelmus Jacobus Van Gestel, Eindhoven (NL); Eric Hendrik Jozef Persoon, Eindhoven (NL)

Correspondence Address: U.S. Philips Corporation, 580 White Plains Road, Tarrytown, NY, 10591, US

(21) Appl. No.: 10/127,482

(22) Filed: Apr. 22, 2002

(30) Foreign Application Priority Data
Apr. 25, 2001 (EP) 01201498.1

(51) Int. Cl. H04N 5/92; G11B 5/86; G11B 27/00; G11B 3/64; G11B 7/28

(52) U.S. Cl. 386/52; 360/15; 369/84

(57) ABSTRACT

The invention relates to a method of generating processed copies (202) of a stream of audiovisual information (201), in which the processed copies are represented by a playlist file (240). The playlist file (240) indicates which fragments of the original stream of audiovisual information (202) are comprised in the processed copy (202). The method also enables a user to add markers (321) and additional information (421) to the processed copy by incorporating extra information in a playlist file.

The invention relates to a method of generating a processed copy of an original stream of audiovisual information stored on a record carrier, which processed copy comprises at least a fragment of the stream of audiovisual information. The invention also relates to an apparatus for displaying audiovisual information, the apparatus comprising a processing unit which is adapted to generate a processed copy of an original stream of audiovisual information stored on a record carrier, which processed copy comprises at least a fragment of the stream of audiovisual information.

When processing an original stream of audiovisual information and/or copying the original stream of audiovisual information or fragments of the original stream of audiovisual information, use is made of cutting and pasting information from the original stream of audiovisual information to which, if desired, extra data is pasted. The known method has the drawback that the original information is lost as soon as the original stream of audiovisual information is processed. The known method has the further problem that a copy, when generated from the original stream of audiovisual information, occupies extra space on a recording medium, in addition to the original stream of audiovisual information.

It is an object of the invention to enable a user to generate and display a processed copy of the original stream of audiovisual information in such a manner that the original stream of audiovisual information remains intact and the processed copy of the audiovisual information occupies much less space than in the case where fragments of the original stream of audiovisual information would be actually copied.

This object is achieved by means of the method according to the invention, which is characterized in that a playlist file indicating which fragments of the original stream of audiovisual information must be comprised in the copy is formed for each processed copy, and in that an apparatus, adapted to read audiovisual information from a record carrier, generates the copy with reference to the playlist file and the original stream of audiovisual information.

The method according to the invention has the advantage that a playlist file representing the processed copy of the original stream of audiovisual information generally occupies much less space on a record carrier than a copy which physically consists of fragments of the original stream of audiovisual information.

An additional advantage is that the method according to the invention provides the possibility of processing the original stream of audiovisual information without the original information of the original stream of audiovisual information getting lost. In a further implementation of the method according to the invention, this advantage also applies when the processed copy is provided with additional information. The additional information, such as, for example, a text fragment, an image, a sound fragment or a film fragment is added to the processed copy in the further implementation of the method according to the invention by storing the additional information on the record carrier on which the original stream of audiovisual information is also recorded. Subsequently, the location where and how the additional information is to be taken up in the processed copy at the instant when the processed copy is generated is indicated in the playlist file.

In another implementation of the method according to the invention, it is also possible to add markers to the processed copy. These markers enable a user to browse through the processed copy in a simpler way as compared with the case where he can only make use of the standard trick modes such as fast forward and fast rewind, which are known to those skilled in the art. In accordance with the other implementation of the method, references of the markers are stored in the playlist file.

The apparatus according to the invention is characterized in that the processing unit is adapted to form a playlist file for each processed copy, which playlist file indicates which fragments of the original stream of audiovisual information must be comprised in this copy.

These and other aspects of the invention are apparent from and will be elucidated with reference to the embodiments described hereinafter.

In the drawings:

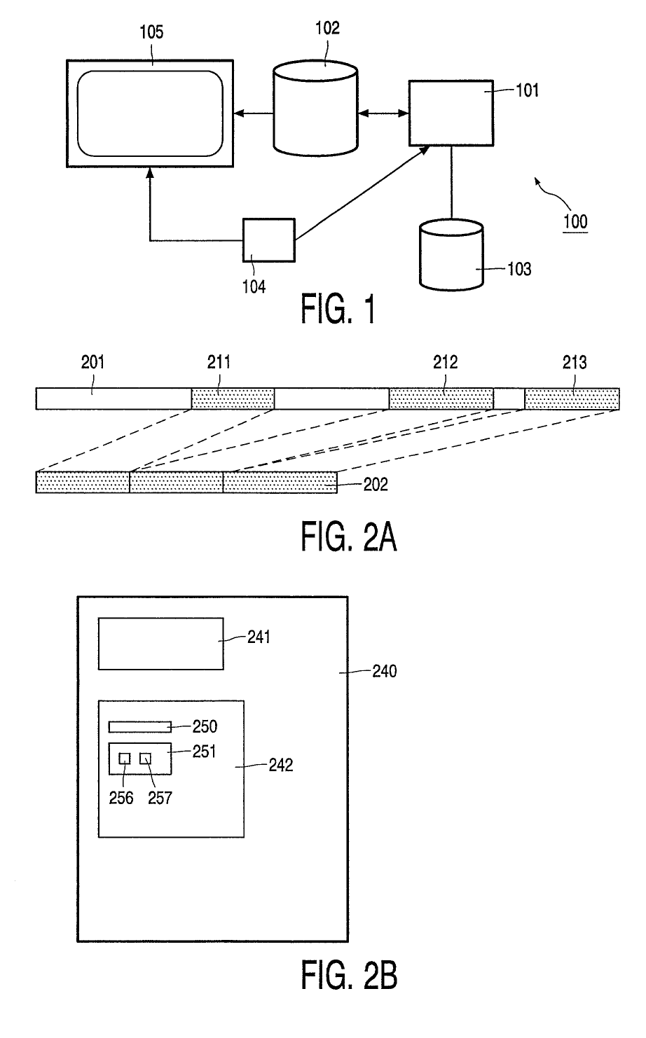

FIG. 1 shows a system for storing and displaying streams of audiovisual information,

FIG. 2A shows an original stream of audiovisual information and a processed copy thereof,

FIG. 2B shows diagrammatically a simple playlist file,

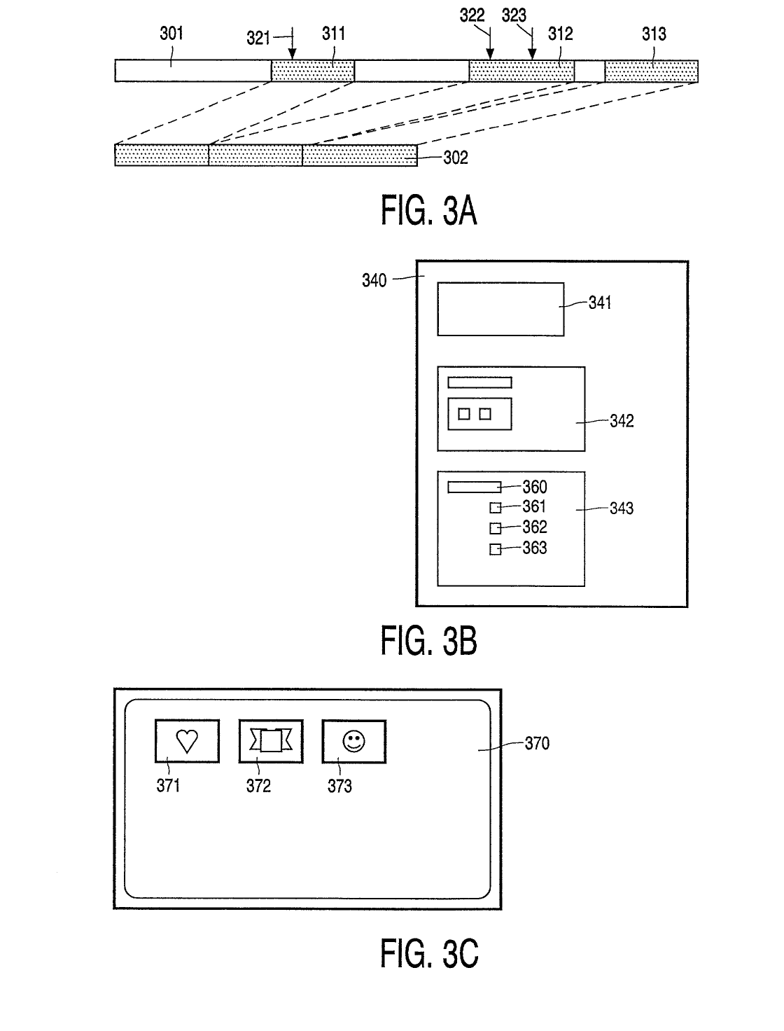

FIG. 3A shows an original stream of audiovisual information and a processed copy thereof, with markers,

FIG. 3B shows diagrammatically an extended playlist file with marker-related data,

FIG. 3C shows a mosaic image with visual information representing markers,

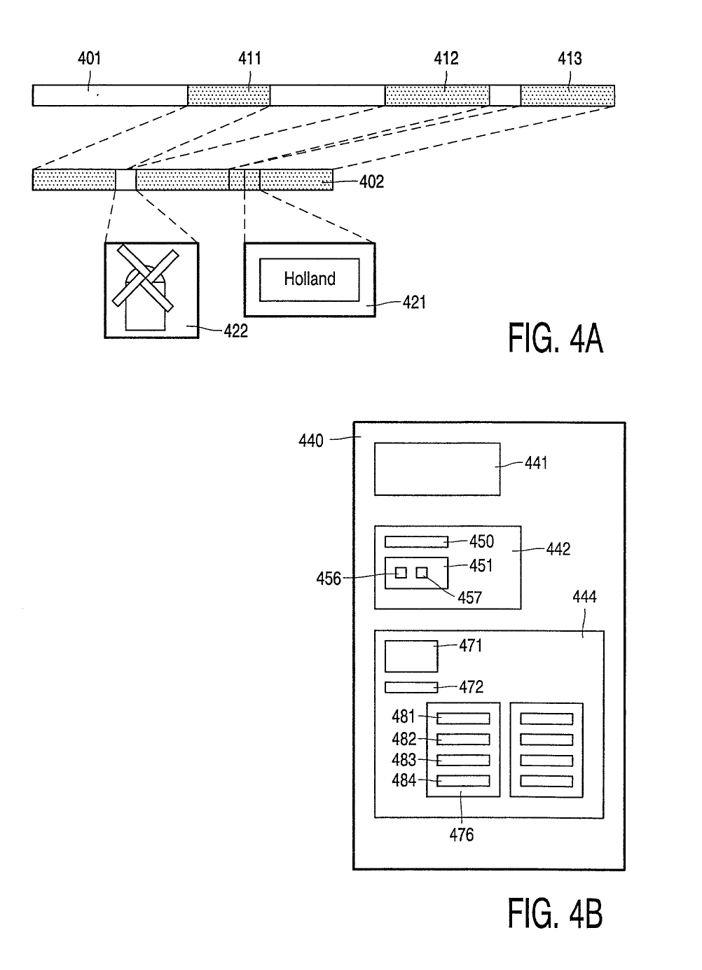

FIG. 4A shows an original stream of audiovisual information and a processed copy thereof with additional information,

FIG. 4B shows diagrammatically an extended playlist file with action-related data,

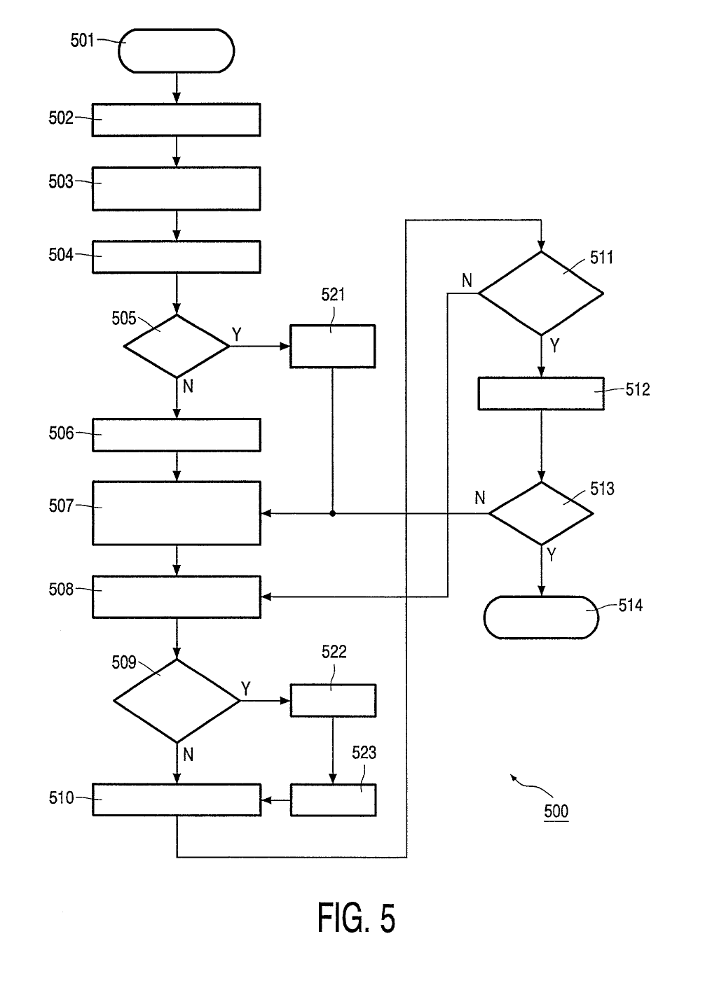

FIG. 5 is a flow chart of playing steps for displaying a processed copy with additional information,

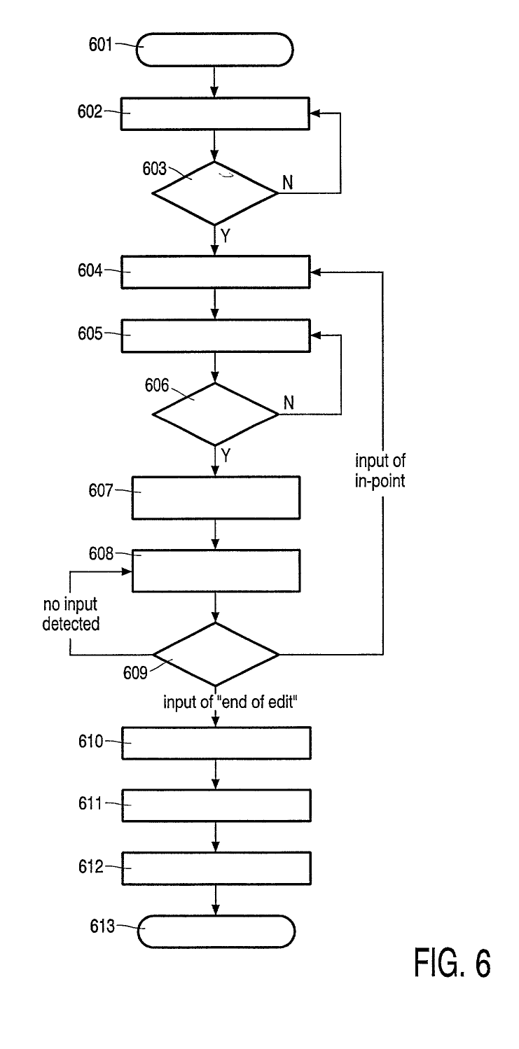

FIG. 6 is a flow chart of processing steps for generating a processed copy of an original stream of audiovisual information.

FIG. 1 shows a possible implementation of a system 100 for generating processed copies of an original stream of audiovisual information by means of the method according to the invention. The system comprises a processing unit 101, a first memory 102, a second memory 103, an operating panel 104 and a display device 105. The original stream of audiovisual information is stored in the first memory 102. The first memory 102 may be a fixed hard disc or a fixed optical disc in system 100, but it is alternatively possible to use, for example, a removable hard disc or a removable optical disc, or a removable or solid state memory. This also applies to the second memory 103.

FIG. 2A shows an original stream of audiovisual information 201 which is stored in the first memory 102 (FIG. 1). The method according to the invention enables the user to generate a plurality of processed copies of the original stream of audiovisual information 201. FIG. 2A shows a processed copy 202 of the original audiovisual stream of information 201. The processed copy 202 comprises a fragment of the original stream of information 201. In the implementation shown, the processed copy 202 comprises a first fragment 211, a second fragment 212 and a third fragment 213.

The processed copy is represented by a playlist file 240 in FIG. 2B. The playlist file 240 comprises at least an address table 241 with the addresses of at least a sub-table of the playlist file 240 and a sub-table playlist 242. The sub-table playlist 242 comprises an indicator 250 which indicates how many components are comprised in the sub-table playlist 242. The sub-table playlist 242 further comprises a component 251. The component 251 of the sub-table playlist 242 represents a fragment of the original stream of audiovisual information 201, associated with the processed copy 202 which is represented by the playlist file 240. The component 251 represents, for example, the fragment 211 associated with the processed copy 202. The component 251 comprises an in-point 256 and an out-point 257. An in-point is the starting point of a fragment and is a location in the original stream of audiovisual information 201. An out-point is the end point of a fragment and is a location in the original stream of audiovisual information 201.

In a further implementation of the invention, a processed copy can be extended by means of markers. FIG. 3A shows an original stream of audiovisual information 301 and a processed copy 302 comprising a first fragment 311, a second fragment 312 and a third fragment 313 of the original stream of audiovisual information 301. The processed copy 302 is represented by a playlist file 340 (FIG. 3B), which comprises an address table 341. The information about in-points and out-points of the fragments is stored in a sub-table playlist 342 of the playlist file 340.

A first marker 321 is indicated in the fragment 311 and a second marker 322 and a third marker 323 are indicated in fragment 312. To couple these markers to the processed copy, the playlist file 340 comprises a marker sub-table 343 whose address information is stored in the address table 341. The marker sub-table 343 comprises an indicator 360 which indicates how many marker references are comprised in the marker sub-table 343. Moreover, the marker sub-table 343 comprises at least one marker reference 361.

Each marker represents a location in the original stream of audiovisual information 301. In the implementation shown, the marker sub-table 343 comprises a first marker reference 361, which refers to the first marker 311, a second marker reference 362, which refers to the second marker 312, and a third marker reference 362 which refers to the third marker 313. In the shown implementation of the invention, the location is a frame number in the stream of audiovisual information 301, but it is alternatively possible to indicate the location in the form of, for example, a point of time.

It is further possible to enable a user to browse through the processed copy in an accelerated manner by way of the markers 321, 322 and 323. In a possible implementation, the user can go to a subsequent marker by using entry means (not shown) on the operating panel 104 (FIG. 1) while the processed copy is being displayed on the display device 105 (FIG. 1). In this way, it is possible for the user to go to the second marker 322 in the fragment 312 while watching the fragment 321 and to further watch the processed copy on the display device 105 (FIG. 1) as from the second marker 322.

A further possibility of browsing through the processed copy is shown in FIG. 3C. As stated hereinbefore, a marker is coupled in the presented implementation of the invention to a frame in an original stream of audiovisual information. By displaying visual information of frames to which the markers refer in a mosaic picture on display device 105 (FIG. 1), the user is given a survey of all markers. This is shown in FIG. 3C. By means of the information in the marker sub-table 343, the processing unit 101 (FIG. 1) can look up the markers 321, 322 and 323 in the original stream of audiovisual information, associated with the marker references 361, 362 and 363, and look up the associated frames. Subsequently, the visual information of these frames is displayed on the display device 105 (FIG. 1). FIG. 3C shows a mosaic picture 370 with an image 371, i.e. the visual information of the frame in the original stream of audiovisual information 301 associated with the marker 321. Furthermore, the mosaic picture 370 comprises an image 372, i.e. the visual information of the frame in the original stream of audiovisual information 301 associated with the marker 322, and an image 373, i.e. the visual information of the frame in the original stream of audiovisual information 301 associated with the marker 323. Now, the user can choose an image of the mosaic picture 370 by way of entry means (not shown) on the operating panel 104 (FIG. 1), in order to choose a point from which he wants to watch the processed copy 302. If the user selects, for example, the image 372 of the mosaic picture 370, the processed copy will be shown from the marker 322. In this way, a part of the second fragment 312 will be displayed, from marker 322 to the out-point of fragment 312, and the fragment 313 will be subsequently displayed completely.

In another implementation of the invention, additional information is added to a processed copy. The additional information may be, for example, an image, a photo, a text fragment, a sound fragment, a film fragment but a different form of information is also possible. The additional information may be stored in memory 102 (FIG. 1) by means of, for example, a PC or a digital photo or video camera (not shown). It is then possible to display the additional information between two fragments of a processed copy. It is also possible to display additional information, for example, a text fragment, on the display device 105 (FIG. 1) simultaneously with the display of a fragment of the original stream of audiovisual information.

FIG. 4A shows a processed copy 402 of an original stream of audiovisual information 401. The processed copy 402 comprises a first fragment 411, a second fragment 412 and a third fragment 413. The processed copy 402 is represented by a playlist file 440 in FIG. 4B which comprises at least an address table 441 with the addresses of at least a playlist file sub-table 440 and at least a sub-table playlist 442. The sub-table playlist 442 comprises an indicator 450 which indicates how many components are comprised in the sub-table playlist 442. The sub-table playlist 442 further comprises a component 451 with an in-point 456 and an out-point 457 so that the component 451 represents a fragment of the original stream of audiovisual information 401, associated with the processed copy 402.

The processed copy 402 is now extended by additional information in the form of a text fragment 421 and an image 422. To display this additional information on the display device 105 (FIG. 1) while the processed copy 402 is being read from the memory 102 (FIG. 1), the playlist file 440 is extended by an action sub-table 444.

The action sub-table 444 comprises a block of general information 471. The block of general information 471 may comprise information about the format of the action sub-table 444. It is alternatively possible to store information about a user who has created the action sub-table 444, or information relating to a system on which the playlist has been created. An indicator 472 in the sub-table 444 indicates how many actions are comprised in the sub-table 444. Moreover, the action sub-table 444 comprises at least an action 476. The action 476 comprises an indicator 481 indicating the type of action represented by the action 476, a reference 482 indicating the information needed by the action, which may be, for example, the image 422, an in-point 483 indicating when the action 476 must start and a period 484 indicating the length of the action.

FIG. 4A shows two possible actions. An example of an action, shown in FIG. 4A is that the image 421 is displayed between the first fragment 411 and the second fragment 412 of the processed copy 402 during period 431 while the processed copy 402 is being displayed on the display device 105 (FIG. 1). A further example of an action, shown in FIG. 4A, is that the text fragment 422 is displayed during the third fragment 413 while the processed copy 402 is being displayed on display device 105 (FIG. 1), which text fragment and the images of the original stream of audiovisual information overlap each other during period 432. Other possibilities of actions are an overlap of the starting point and the end point of two fragments in the processed copy or a fade-in/fade-out of two fragments. Moreover, it is possible to display a film fragment instead of an image or a text fragment and/or reproduce a sound fragment by means of the display device 105 (FIG. 1). Furthermore, there are many other action possibilities which are known to those skilled in the art.

In FIG. 5, a flow chart 500 of playing steps shows how the processed copy 402 (FIG. 4A) is displayed on the display device 105 (FIG. 1) by means of the system 100 (FIG. 1) in accordance with the presented implementation of the invention. Playing the processed copy 402 (FIG. 4A) starts with a process 501, meaning that the playlist file 440 (FIG. 4B) representing the processed copy 402 (FIG. 4A) is selected. Since the playlist file is stored in the first memory 102 (FIG. 1) in the presented implementation of the method, the playlist file is loaded from the first memory 102 (FIG. 1) into the second memory 103 (FIG. 1) after selection of the playlist file 440 (FIG. 4), which is a process 502 in the play flow 500. Subsequently, the system 100 (FIG. 1) generates, in a process 503 and using the processing unit 101 (FIG. 1), a play row with the first fragment 411, the second fragment 412 and the third fragment 413 (FIG. 4A) in this implementation, each fragment consisting of an in-point indicating the start of the relevant fragment in the original stream of audiovisual information 401 (FIG. 4A), and an out-point indicating the end of the relevant fragment in the original stream of audiovisual information 401. In the presented implementation, the play row is stored in the second memory 103 (FIG. 1). When the process 503 has been finished, a frame counter (not shown) is initialized in a process 504. In a later process of the play flow 500, the frame counter counts how many frames of the original stream of audiovisual information 401 (FIG. 4A) associated with the processed copy 402 (FIG. 4A) have been displayed on a display device 105 (FIG. 1). In the presented implementation, the counter counts the displayed frames but it is of course alternatively possible for the counter to keep up the elapsed time or the time still to go.

Subsequently, it is checked in a decision step 505 whether the system 100 (FIG. 1) recognizes the action sub-table 444 (FIG. 4B) in the playlist file 440. This is tested with reference to the block of general information 471 of the action sub-table 444 (FIG. 4B). If the system 100 (FIG. 1) recognizes the action data, the processing unit 101 (FIG. 1) generates an action row in a process 521 which is stored in the second memory 103 (FIG. 1) in the implementation shown. If the system 100 (FIG. 1) does not recognize the action sub-table 444 (FIG. 4B), the processing unit 101 (FIG. 1) generates an empty action row in a process 506, which action row is stored in the second memory 102 (FIG. 1). After generating an action list in the process 521 or in the process 506, a first frame of a first fragment in the play row is searched in the original stream of audiovisual information 401 (FIG. 4A) in a process 507. In a process 508, the first frame of the first fragment is displayed on display device 105 (FIG. 1). Subsequently, a decision step 509 is performed in which it is ascertained whether the value of the counter corresponds to the in-point 483 (FIG. 4B) of a first action of the action list generated in the process 521 or the process 506. If the counter corresponds to the in-point 483 (FIG. 4B) of the first action of the action list, the action is performed in a process 522.

If the action involves a display of a further image on display device 105 (FIG. 1) for a longer period of time, while the subsequent frames of the original stream of audiovisual information 401 (FIG. 4A) associated with the processed copy 402 (FIG. 4A) must also be displayed, a further counter will have to start in a sub-routine (not shown). Upon display of every subsequent frame, this further counter is compared in the process 508 with the period 484 (FIG. 4B) until the values of the period 484 and of the further counter are equal. In the intermediate period, the further image will be displayed on the display device 105 (FIG. 1). If the values of the period 484 and the further counter are equal, the further counter will be initialized and the further image will no longer be displayed on display device 105 (FIG. 1). In a further embodiment, a sound fragment may be reproduced instead of displaying an image.

If the action involves the display of a piece of additional information between two fragments of the processed copy, the play flow remains in process 522 and the additional information is displayed during the period indicated in the action data of the action. After performing this action, the play flow 500 changes to a subsequent process.

After performing the action, the action is removed from the action row in a process 523 in order that a subsequent action will come first in the row. Subsequently, the frame counter is incremented by 1 in a process 510 in the implementation shown. If the value of the counter and the in-point 483 (FIG. 3) do not correspond in the decision step 509, the process 510 is directly initiated and performed. After incrementing the counter in the process 510, a decision step 511 follows. In the decision step 511, the value of the counter is compared with the out-point of the fragment which is being played. If the counter and the out-point of the fragment which is being played do not correspond, the process 508 is initiated again from the decision step 511. If the counter and the out-point of the fragment which is being played correspond, a process 512 is initiated. In the process 512, the representation of the played fragment comprising the in-point and the out-point is removed from the play row.

After the process 512, a decision step 513 follows, in which step it is checked whether the play row comprises still a further fragment. If this is the case, the in-point of the next fragment of the play row associated with the processed copy 402 (FIG. 4A) is searched in the original stream of audiovisual information 401 (FIG. 4A) in the process 507. If the play row is empty in the decision step 513, playing of the processed copy is terminated at an end point 514. Playing of the copy may of course also be terminated by means of the standard trick mode stop which is known to those skilled in the art. Moreover, it is possible to enable the user to make use of the standard trick modes known to those skilled in the art, such as fast forward and fast rewind when the processed copy 402 (FIG. 4A) is being displayed on the display device 105 (FIG. 1). The play flow 500 described here is only an embodiment of the invention and more embodiments within the scope of the method presented are of course alternatively possible.

There are many possibilities of creating a playlist file to represent a processed copy of an original stream of audiovisual information in the implementation of the method shown. A possible implementation of creating a playlist file is shown in FIG. 6. This Figure shows a flow chart 600 of processing steps enabling a user to create a playlist file with a sub-table playlist by means of the standard trick modes and by creating in-points and out-points. This will be elucidated with reference to the flow chart 600 of processing steps. The processing flow 600 starts at the instant when the system 100 (FIG. 1) is set to a processing state. The user can set the system 100 (FIG. 1) to the processing state by way of an entry means (not shown) on the operating panel 104 (FIG. 1). The processing flow 600 starts at a starting point 601. The user can subsequently select a first in-point of a first fragment of the processed copy by way of an entry means (not shown) on the operating panel 104 (FIG. 1), while the system 100 (FIG. 1) waits to select an in-point of a first fragment in a process 602. To search the in-point in the original stream of audiovisual information, the user can use the standard trick mode entry means on the operating panel 104 (FIG. 1), with the original stream of audiovisual information being displayed on the display device 105 (FIG. 1) in accordance with the commands given by means of the operating panel 104. If the system 100 (FIG. 1) detects that the user has selected the first in-point of the first fragment, the processing flow 600 proceeds in a decision step 603 to a process 604 in which the first in-point of the first fragment is stored in the second memory 103 (FIG. 1) in accordance with the presented implementation of the method described.

After preserving the selected in-point in the process 604, the processing flow 600 proceeds to a process 605 enabling the user to select an out-point of the first fragment by way of entry means (not shown) on the operating panel 104 (FIG. 1). During the process 605, the user can make use of the standard trick mode entry means (not shown) on the operating panel 104 (FIG. 1), with the original stream of audiovisual information being displayed on the display device 105 (FIG. 1) in accordance with the commands given by means of the operating panel 104 (FIG. 1). If the system 100 (FIG. 1) detects that the user has selected a first out-point, the processing flow 600 proceeds in a decision step 606 to a process 607 in which the first out-point of the first fragment is stored in the second memory 103 (FIG. 1) in accordance with the presented implementation. Moreover, the processing unit 101 (FIG. 1) forms the first fragment in the playlist sub-table of the playlist file by means of the first in-point and the first out-point. The representation of the first fragment of the processed copy, which comprises the first in-point and the first out-point, is stored in the second memory 103 (FIG. 1) in the presented implementation.

By enabling the user to make use of the trick modes, it is possible to select the first out-point before the first in-point in the original stream of audiovisual information. This yields an incorrect fragment. If the out-point is selected before the in-point, the system 100 (FIG. 1) in the embodiment shown gives an error message and the system 100 enables the user to select an out-point for the second time.

In another implementation it is alternatively possible that, when selecting the first out-point, the fast rewind operation by means of the standard trick mode prevents the user from rewinding further than the first in-point. This is possible by imposing a limit on the system 100 (FIG. 1). In this way, the user is prevented from selecting the first out-point before the first in-point and thus from creating an incorrect fragment.

After the first fragment has been stored in the process 607, a waiting time for entry by the user is observed in a process 608. The user can search and select a second starting point of a second fragment by way of entry means (not shown) on the operating panel 104 (FIG. 1). The user can also eliminate the process setting operation in the system 100 (FIG. 1) by way of entry means (not shown) on the operating panel 104 (FIG. 1). The entry is evaluated in a decision step 609. If no entry is detected, the processing flow reverts to the process 608. Upon detecting the selection of a new in-point by means of entry via the operating panel 104 (FIG. 1), the processing flow 600 proceeds to the process 604, where the processing flow 600 further proceeds as described.

Upon detecting entry of a command via operating panel 104 (FIG. 1) for eliminating the process setting in system 100 (FIG. 1), the processing flow 600 proceeds after the decision step 609 to a process 610 in which the sub-table playlist with at least the first fragment is stored in the second memory 103 (FIG. 1) in accordance with the presented implementation. After completion of the process 610, the processing flow 600 proceeds to a process 611. In the process 611, an address table for the playlist file to be created in the next step is generated. In the process 612, the playlist file is subsequently formed with the sub-table playlist and the address table, and the playlist file is stored in the first memory 102 (FIG. 1), in addition to the original stream of audiovisual information. It is of course alternatively possible to store the playlist file in the second memory 103 (FIG. 1). After storage of the playlist file, the processing flow 600 terminates at an end point 613.

It is alternatively possible for the user to select markers in the original stream of audiovisual information, if system 100 (FIG. 1) is in its process setting operation, which markers are also stored in the playlist file. A marker sub-table is then generated for the markers, which sub-table is stored in the playlist file.

After creating a playlist file in accordance with the processing flow 600 (FIG. 6), the user may add additional information such as actions and markers to the processed copy which can be displayed on display device 105 (FIG. 1) in accordance with the play flow 500 (FIG. 5). This is possible by means of a PC (not shown), but it is alternatively possible to enable the user to add the additional information to the processed copy by using system 100 (FIG. 1) and with the aid of a user interface (not shown).

1. A method of generating a processed copy (202) of an original stream of audiovisual information (201) stored on a record carrier (102), which processed copy comprises at least a fragment (211) of the original stream of audiovisual information (201), characterized in that
(a) a playlist file (240) indicating which fragments of the original stream of audiovisual information (201) must be comprised in the copy (202) is generated for each processed copy (202),
(b) an apparatus, adapted to read audiovisual information from the record carrier (102), generates the copy (202) with reference to the playlist file (240) and the original stream of audiovisual information (201).

2. A method as claimed in claim 1, characterized in that the fragments are ordered in the playlist file (240) in a different sequence than in the original stream of audiovisual information (201).

3. A method as claimed in claim 1, characterized in that at least a marker (321) is indicated in the processed copy.

4. A method as claimed in claim 3, characterized in that said marker is coupled to a frame in the original stream of audiovisual information.

5. A method as claimed in claim 3, characterized in that said marker is stored in the playlist file.

6. A method as claimed in claim 3, characterized in that a user can display the copy as from said marker on a display device.

7. A method as claimed in claim 6, characterized in that the method comprises at least the steps of:
(a) displaying the visual information (371) which represents the marker,
(b) enabling the user to select the marker.

8. A method as claimed in claim 1, characterized in that a user can display at least one of the following forms of additional information between the fragments of the copy:
(a) text fragments
(b) images
(c) sound fragments
(d) film fragments
with the additional information being stored together with the playlist file and a location of the additional information in the copy being indicated in the playlist file.

9. A method as claimed in claim 1, characterized in that a user can display at least one of the following forms of additional information during at least one of the fragments of the copy:
(a) text fragments
(b) images
(c) sound fragments
(d) film fragments
with the additional information being stored together with the playlist file and a location of the additional information in the copy being indicated in the playlist file.

10. An apparatus for displaying audiovisual information, the apparatus comprising a processing unit which is adapted to generate a processed copy of an original stream of audiovisual information stored on a record carrier, which processed copy comprises at least a fragment of the stream of audiovisual information, characterized in that the processing unit is further adapted to
(a) form a playlist file for each processed copy, which playlist file indicates which fragments of the original stream of audiovisual information must be comprised in the copy
(b) generate the processed copy with reference to the playlist file and the original stream of audiovisual information.
